(19) United States
(12) Patent Application Publication
(10) Pub. No.: US 2009/0200797 A1
(43) Pub. Date: Aug. 13, 2009

(54) PIPE FITTING AND PIPE COUPLING ASSEMBLY EMPLOYING SUCH FITTING

(75) Inventors: Glenn Carson, Sarnia (CA); Graham T. Brown, Sarnia (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(73) Assignee: Car-Ber Investments Inc., Point Edward (CA)

(21) Appl. No.: 12/425,981

(22) Filed: Apr. 17, 2009

Related U.S. Application Data
(63) Continuation of application No. PCT/CA2007/001825, filed on Oct. 17, 2007.
(60) Provisional application No. 60/829,818, filed on Oct. 17, 2006.

(51) Int. Cl. F16L 21/06; F16L 25/00; F16L 23/024; F16L 23/036

(52) U.S. Cl. 285/323; 285/330; 285/413; 285/414

(57) ABSTRACT

A fitting for fixedly attaching to pipes and the like includes an inner and outer ring being coaxially provided over a pipe. The inner and outer rings are preferably connected by means of a ratchet mechanism allowing for one way advancement there-between. Advancement of the outer ring over the inner ring radially compresses the latter thereby resulting in swaging of the pipe. The radial compression of the pipe results in the fitting being locked in place and prevents axial movement between the fitting and the pipe. Various apparatus are provided for advancing the outer ring over the inner ring. Coupling assemblies are provided utilizing the fittings for forming joints between abutting pipes.

### CROSS REFERENCE TO PRIOR APPLICATIONS

This application is a Continuation of PCT application number PCT/CA2007/001825, filed Oct. 17, 2007, which claims priority from U.S. application No. 60/829,818, filed Oct. 17, 2006. The entire contents of the aforementioned prior applications are incorporated herein by reference.

### FIELD OF THE INVENTION

The present invention relates to pipe fittings and the like and to pipe coupling assemblies for joining pipes incorporating such fittings.

### DESCRIPTION OF THE PRIOR ART

Various types of fittings are known in the art for coupling tubes and pipes together. Generally, the known fittings include a sleeve that is coaxially provided over the pipe. A swage ring is then axially advanced over the sleeve causing radially inward deformation (i.e. radial compression) of the sleeve. Such deformation causes a localised deformation of the tube or pipe, thereby providing a tight fit between the sleeve and the pipe. Examples of the types of known fittings are provided in U.S. Pat. Nos. 6,450,553 and 5,114,191 and in U.S. Published Application US/2006/0186666.

One of the problems associated with known swage type fittings (as described above) comprises axial movement of the swage ring after the fitting is in place. Thus, movement of the swage ring may compromise the integrity of the fitting placement. To address this problem, U.S. Pat. Nos. 5,181,752 and 6,692,040 have proposed a locking mechanism between the sleeve and the swage ring. However, such locking mechanisms (such as taught in U.S. Pat. No. 5,181,752) are designed to be engaged after almost complete advancement of the swage ring over the sleeve. Further, these locking mechanisms include a grooved or roughened surface to enhance a friction fit between the sleeve and the swage ring. However, such surfaces would also inhibit advancement of the swage ring.

Another problem with the known swage fitting devices is the requirement for often complex apparatus for advancing the swage ring. In addition, the known swage type fittings are typically designed for small diameter tubes and pipes (i.e. less than 2 inches in diameter). When coupling pipes of larger diameters, flanges and the like are typically used since the swage type devices are not adequate under the pressures developed in larger pipes.

A further problem with the known devices lies in the requirement of a unitary inner sleeve when joining two pipes together. In such case, the ends of the pipes are inserted into opposite ends of the sleeve and then the respective swage rings are advanced. Such an arrangement is often cumbersome and sometimes ineffective for pipes of larger diameters.

The present invention serves to address one or more of the aforementioned deficiencies in the prior art devices.

### SUMMARY OF THE INVENTION

In one aspect, the present invention provides a fitting usable for various diameter pipes.

In another aspect, the present invention provides a fitting for pipes and the like having an inner ring or sleeve over the pipe and an outer, compression or swage ring overlying the inner ring. A locking system is provided between the ring and the sleeve to prevent undesired axial movement there-between.

In another aspect, the invention provides a one-way locking mechanism between the sleeve and the compression ring.

In a further aspect, the invention provides an apparatus for engaging the sleeve and the compression ring.

In another aspect, the invention provides a coupling assembly for joining pipes involving various versions of fittings of the invention.

In a further aspect, the invention provides a fitting that can be heat fitted or welded to a pipe.

In a further aspect, the invention provides a pipe fitting for circumferential attachment to a pipe by swaging comprising:

an inner ring adapted to be provided over the pipe; and,

an outer ring adapted to be provided over the inner ring;

said inner ring having an outer surface including a first set of teeth;

said outer ring having an inner surface including a second set of teeth;

wherein said first and second sets of teeth are adapted to engage each other as said outer ring is urged over the inner ring.

In a further aspect, the invention provides a method of providing a fitting over a pipe comprising:

providing an inner ring over the pipe,

providing an outer ring adapted to fit over the inner ring;

urging the outer ring over the inner ring to cause radial compression of the inner ring over the pipe and thereby swaging of the pipe;

locking the respective axial positions of the inner and outer rings to prevent separation thereof.

In another aspect, the invention provides a coupling assembly for joining the ends of first and second pipes comprising:

a first fitting adapted to be secured to the first pipe;

a second fitting adapted to be secured to the second pipe;

each of the first and second fittings comprising:
an inner ring adapted to be provided over the pipe; and,
an outer ring adapted to be provided over the inner ring;
said inner ring having an outer surface including a first set of teeth;
said outer ring having an inner surface including a second set of teeth;
wherein said first and second sets of teeth are adapted to engage each other as said outer ring is urged over the inner ring;

a connector joining the first and second fittings to prevent axial separation there-between.

In another aspect, the invention provides a method of joining the ends of pipes comprising:

providing a first fitting on a first pipe and a second fitting on a second pipe, each of said fittings comprising an inner and outer ring and each of said steps comprising:
a) providing an inner ring over the pipe;
   b) providing an outer ring adapted to fit over the inner ring;
   c) urging the outer ring over the inner ring to cause radial compression of the inner ring over the pipe and thereby swaging of the pipe;
d) locking the respective axial positions of the inner and outer rings to prevent separation thereof;

axially aligning said first and second pipes and providing a seal there-between;

urging said pipes together; and,

connecting the first and second fittings to prevent relative movement there-between.

In a further aspect, the invention provides a coupling assembly for joining the ends of first and second pipes wherein said second pipe is provided with a flange, the assembly comprising:

a fitting adapted to be secured to the first pipe, said fitting comprising:
an inner ring adapted to be provided over the pipe; and,
an outer ring adapted to be provided over the inner ring;
said inner ring having an outer surface including a first set of teeth;
said outer ring having an inner surface including a second set of teeth;
wherein said first and second sets of teeth are adapted to engage each other as said outer ring is urged over the inner ring; and,

a flange plate connected to said fitting, said flange plate comprising:
a generally annular disc having a central aperture corresponding to the lumen of the first pipe and a seal for sealingly engaging the end of the first pipe; and,
including bolt holes corresponding to bolt holes on said flange of the second pipe.

In another aspect, the invention provides a method of coupling a first pipe to a second pipe having a flange comprising:

providing a fitting on the first pipe comprising the steps of:
a) providing an inner ring over the first pipe;
b) providing an outer ring adapted to fit over the inner ring;
c) urging the outer ring over the inner ring to cause radial compression of the inner ring over the first pipe and thereby swaging of the first pipe;
d) locking the respective axial positions of the inner and outer rings to prevent separation thereof;

providing a flange plate over an end of the first pipe, the flange plate covering the opening of the first pipe;

connecting the flange plate to the fitting;

axially aligning an end of said first pipe with the flange end of the second pipe and urging said pipes together; and,

securing the flange plate of the first pipe to the flange of the second pipe.

In another aspect, the invention provides a coupling assembly for sealing the end of a pipe comprising:

a fitting adapted to be secured to the pipe, said fitting comprising:
an inner ring adapted to be provided over the pipe; and,
an outer ring adapted to be provided over the inner ring;
said inner ring having an outer surface including a first set of teeth;
said outer ring having an inner surface including a second set of teeth;
wherein said first and second sets of teeth are adapted to engage each other as said outer ring is urged over the inner ring; and,

a flange plate connected to said fitting, said flange plate comprising:
a generally annular disc having a central aperture corresponding to the lumen of the first pipe and a seal for sealingly engaging the end of the first pipe; and,
a plurality of circumferentially spaced bolt holes; and,

a blind flange for securing to the flange plate.

Thus, in one aspect, the invention provides a method of providing a fitting over a pipe comprising:

providing a metal collar formed of a thermally expandable material, said collar having an inner diameter that is smaller than the external diameter of the pipe;

heating the collar to expand the inner diameter;

inserting the pipe through the collar inner diameter;

cooling the collar to return the collar inner diameter to the non-expanded size;

whereby said collar swages the pipe.

### BRIEF DESCRIPTION OF THE DRAWINGS

These and other features of the invention will become more apparent in the following detailed description in which reference is made to the appended drawings wherein:

FIG. 1 is a cross sectional view of a fitting of the invention being mounted on a pipe.

FIG. 2 is a cross sectional view of the fitting of FIG. 1 after mounting on a pipe.

FIGS. 3 and 4 are cross sectional views showing examples of apparatus used to connect the fitting of FIG. 1 to a pipe.

FIGS. 5 to 8 are cross sectional views illustrating coupling systems using the fittings of FIG. 1 to butt join two axially adjacent pipes.

FIGS. 9 to 12 are cross sectional views illustrating a flange connected to a pipe through the fitting of FIG. 1.

FIGS. 13 to 15 are cross sectional views of variants of the fitting of FIG. 1.

### DETAILED DESCRIPTION OF THE INVENTION

In the present description the terms “coupling ring” and “coupling” are used. The term “coupling ring” will be understood to mean a fitting that is adapted to be attached to the outer surface of a pipe. The term “coupling” will be understood to mean a device that joins two pipes together, preferably in an end to end, or butt-jointed manner.

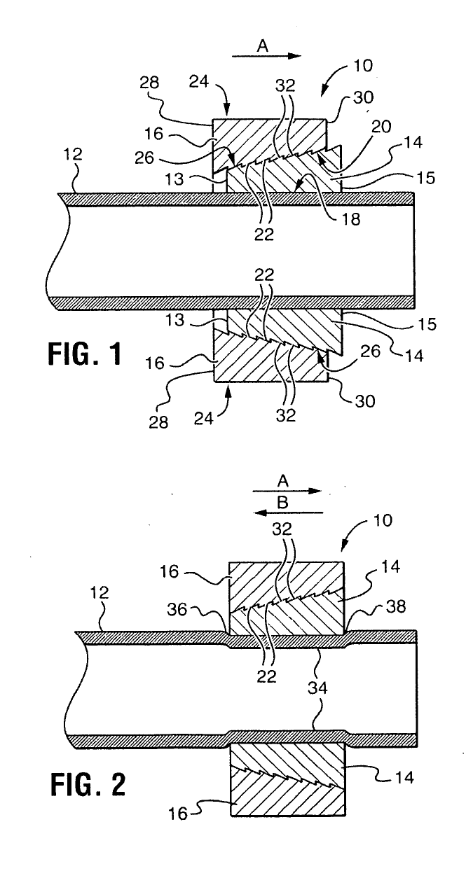

One embodiment of the present invention is illustrated in FIG. 1. In the embodiment shown, a generally ring shaped fitting or coupling ring 10 is coaxially provided over the outer diameter of a pipe 12. The fitting 10 is provided in two sections, namely, an inner ring or sleeve 14 and an outer compression ring 16. The inner and outer rings 14, 16 are generally annularly shaped and include inner and outer surfaces. The inner surface 18 of the ring 14 includes a diameter that is generally constant over its axial length, wherein the diameter is sized to be slidably received over the outer surface of the pipe 12. In general, the inner diameter of the inner ring 14 is preferably only slightly larger than the outer diameter of the pipe 12. The inner surface 18 may be provided with grooves, indentations, ribs or any other structural feature to assist in establishing a tight friction fit with the outer surface of the pipe 12, as will be understood by persons skilled in the art. For convenience, the present figures show the inner surface 18 without such features.

The outer surface 20 of the inner ring 14 is ramped so as to provide the inner ring 14 with a first end 13 having a lesser thickness than the opposite second end 15. Thus, the outer diameter of the ring increases when moving from the first end 13 to the second end 15 of the inner ring 14. The outer surface 20 is preferably also provided with a plurality of angled teeth 22. Preferably, the teeth 22 are provided over substantially the entire surface of the inner ring 14. The teeth 22 are angled towards the thicker end 15 of the inner ring 14. The purpose of such angling will be made clear in the following discussion.

The outer ring 16 is designed similar to the inner ring 14 but opposite in orientation. That is, the outer surface 24 of the outer ring may be generally flat thereby providing the outer ring 16 with a generally constant outer diameter. However, as will be discussed further below, the outer surface 24 of the outer ring 16 may be provided with a number of different structural features to serve various purposes.

The outer ring 16 includes a generally ramp-shaped inner surface 26. Such a structure results in a thicker first end 28 of the outer ring 14 as compared to a thinner second end 30. In other words, the inner diameter of the outer ring 16 gradually decreases from the first end 28 to the second end 30. The inner surface 26 of the outer ring 16 is preferably provided with a plurality of angled teeth 32, wherein such teeth are angled towards the thicker first end 28 of the outer ring 16.

The inner and outer rings 14, 16 are sized so as to allow the inner ring 14 to fit coaxially within the outer ring 16 when the respective first and second ends are aligned.

As shown in FIG. 1, the mounting of the fitting or coupling ring 10 on a pipe 12 first involves providing the inner ring 14 over the pipe 12 wherein the inner ring 14 and the pipe 12 are coaxially arranged. The inner ring 14 is positioned at the desired location on the pipe. The outer ring 16 is then slid coaxially over the inner ring 14. As discussed above, the outer surface 20 of the inner ring 14 and the outer surface 26 of the outer ring 16 are ramped. For this reason, it will be understood that, when the fitting is being mounted, the rings 14, 16 are positioned so as to align the respective first ends 13, 28 and second ends 15, 30 of the inner and outer rings, respectively. In other words, the second end 30 of the outer ring 16, having the maximum inner diameter, is aligned with the second end 15 of the inner ring 14, having the maximum outer diameter. In this arrangement, it will be understood from the above discussion, that the teeth 22 provided on the outer surface 20 of the inner ring 14 will be angled oppositely from the teeth 32 provided on the inner surface 26 of the outer ring 16. This orientation provides a ratchet fit between the inner and outer rings 14, 16 whereby the outer ring 16 is allowed to move in only one axial direction, shown by the arrow A, over the inner ring 14.

FIG. 2 illustrates the fitting 10 of FIG. 1 in its final state, that is, after the outer ring 16 is completely advanced over the inner ring 14. The ratcheting action of the teeth 22, 32 mechanically locks the rings 14, 16 together. It will be understood that the arrangement of the teeth prevent axial movement of the outer ring 16 in the direction indicated by arrow B. Further, the ramped profiles of the rings 14 and 16 prevent axial movement of the outer ring in the direction indicated by arrow A. In the latter case, axial movement in the direction of arrow A is also limited by the amount of deformation of the pipe 12.

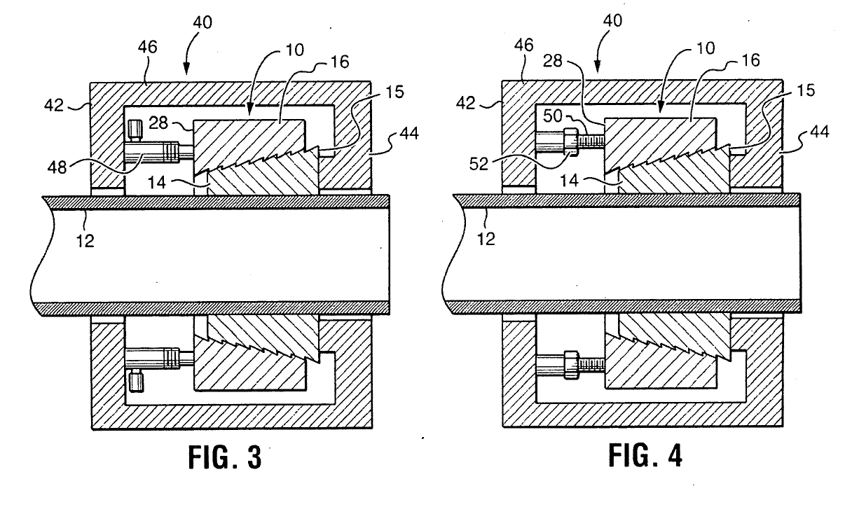

Although the above discussion has referred to the locking mechanism between the inner and outer rings being formed by a combination of oppositely directed ramps and teeth, it will be understood that the same effect may equally be achieved without the need for the teeth. In such case, the inter-engagement between the inner and outer rings may be achieved by a friction fit alone. Alternatively, to assist in increasing the friction between the contacting surfaces of the inner and outer rings, one or both of the surfaces may be provided with ribs, grooves, a roughened texture or any other means as will be apparent to persons skilled in the art. Although such friction fit may not provide a one-way lock as with the ratcheting teeth described above, a brace or other such device may be provided on the fitting to prevent relative axial movement between the inner and outer rings. An example of such brace is discussed below in connection with FIGS. 3 and 4.

As also shown in FIG. 2, as the outer ring 16 is advanced over the inner ring 14, the inner ring would be subjected to a radially compressive force. Such force would then be transferred to the wall of the pipe 12 resulting in swaging of the tube, or a localised reduction of the outer diameter. It will be understood that the tensile strength of the outer ring will be chosen so as to mainly result in deformation of the inner ring. This may be done, for example, by using an outer ring having a greater thickness than the inner ring. It will also be understood that some outward deformation of the outer ring may result in the process. In some instances, as shown in FIG. 2, the inner diameter of the pipe may also be reduced. The compressed region of the pipe 12 is shown at 34.

Once the fitting 10 is secured in place as shown in FIG. 2, it will be understood that the compression of the outer diameter of the pipe creates first and second ledges, 36, 38, on the outer wall of the pipe 12, on opposite ends of the fitting 10. The ledges 36, 38 would serve to inhibit relative axial movement between the fitting 10 and the pipe 12.

As mentioned above, the inner surface 18 of the inner ring 14 may be provided with one or more grooves or ridges etc. (not shown). Such grooves, ridges etc., which may be small in size, serve to increase the frictional fit between the inner ring 14 and the pipe 12. In another embodiment, such grooves may take the form of prominent ribs such as those shown in prior art references discussed above. In such case, as will be understood by persons skilled in the art, the ribs may produce additional ledges such as those shown at 36, 38 of FIG. 2.

FIGS. 3 and 4 illustrate two examples of assemblies that can be used to engage the fitting to the pipe 12. In both cases, the assembly includes a number of brackets 40 extending between the opposite ends of the fitting 10. The brackets, in one embodiment, have a generally “U” shaped profile with a first arm 42, for abutting against the first end 28 of the outer ring 16, and a second arm 44, for abutting against the second end 15 of the inner ring 14. An axially extending connecting arm 46 joins the arms 42 and 44. The second arm 44 of the bracket 40 bears against the second end 15 of the inner ring 14 and prevents axial movement of the inner ring 14 during advancement of the outer ring 16. The first arm 42 of the bracket 40 is provided with an urging means for advancing the outer ring 16 over the inner ring 14. In FIG. 3, such urging means is shown as a hydraulic cylinder 48. A hydraulic fluid (not shown) powers the cylinder 48, whereby an axial separating force is applied against the first arm 42 of the bracket 40 and the first face 28 of the outer ring 16. As will be understood, such force causes the outer ring to move axially towards the inner ring 14. In FIG. 4, an alternate embodiment is shown wherein the urging means comprises a jackbolt 50 or the like. Tightening of the nut 52 provided on the jackbolt serves to apply a similar axially separating force between the first arm 42 and the outer ring 16 as described above. Although two examples of the urging means or mechanism are described above, various other alternatives will be apparent to persons skilled in the art. For example, referring to FIG. 4, the jackbolts 50 can be replaced with bolts that extend through threaded openings (not shown) in the arms 42. Tightening of such bolts would advance them against the outer ring 16 in a manner similar to the jackbolts.

As shown in FIGS. 3 and 4, and as will be understood by persons skilled in the art, it is preferred to have a plurality of brackets 40 generally equidistantly spaced around the circumference of the fitting 10. This arrangement would serve to equally distribute the force generated by the urging means across the circumference of the fitting 10 thereby ensuring that the outer ring fully engages the inner ring. The brackets 40 can be joined together in sections or may be individually provided. It will be appreciated that the number of brackets, and associated urging means will depend upon the size of the pipe 12. For example, for smaller pipes, only four brackets may be needed (placed at 90° intervals), but more brackets may be needed for larger diameter pipes. In a preferred embodiment, the brackets 40 are joined together to form a ring shaped body adapted to encircle the fitting 10. The body would preferably be provided in two sections that are connected together when being installed over the fitting 10. The sections may, in one embodiment, be joined along an end by a hinge. Other variations of the brackets are understood to be within the scope of the present invention.

It will also be understood that the brackets 40 may be left in place after the fitting is installed in order to provide a further lock to prevent the outer ring 16 from axially moving with respect to the inner ring 14. This arrangement may be used, for example, where the contacting surfaces of the inner and outer rings are not provided with the ratcheting teeth. In such case, the brackets 40 would serve as braces to maintain the fitting intact (as described above).

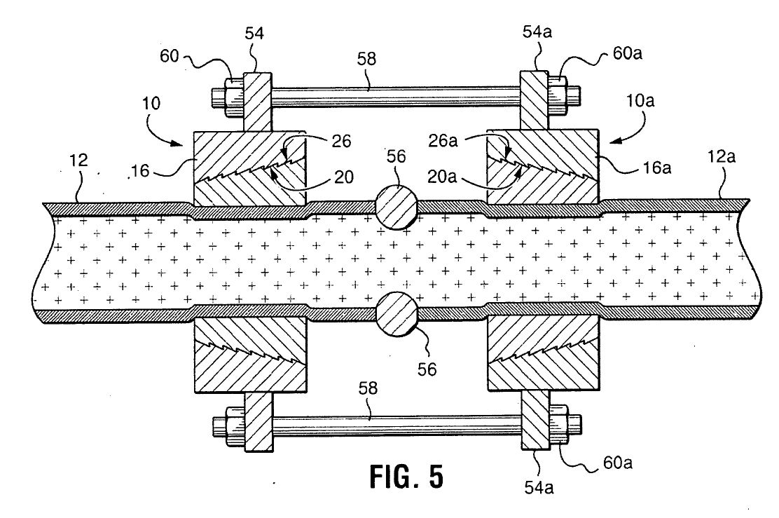

FIG. 5 illustrates an embodiment of the invention which provides a coupling or assembly for butt-joining two pipes together. As shown in FIG. 5, two fittings 10 and 10a are provided, respectively, on pipes 12 and 12a, which are to be joined together. In such case, the fittings 10 and 10a are first secured to the respective pipe in the manner described above. As shown in FIG. 5, the outer surfaces of the rings 16 and 16a of the fittings are provided with a radially outward extending flanges 54 and 54a. The flanges 54, 54a may be unitary structures extending over the entire circumferences of the rings 16, 16a or they may be discontinuous, in the shape of radially protruding tabs. In a preferred embodiment, each of the flanges 54, 54a comprises a radially outward extending flange provided on the outer surface of the outer ring 16. Following installation of the clamps 10, 10a, the opposing ends of the pipes 12, 12a are brought together into abutting alignment. A seal 56 is provided between the opposing ends of the pipes. The seal 56 may comprise any type of resilient sealing member such as a gasket etc. that would be commonly known to persons skilled in the art.

A plurality of connecting rods 58 extend between the flanges 54 and 54a and through apertures provided in the flanges. Cooperating nuts 60, 60a serve to secure the respective ends of the connecting rods 58 to the flanges. As will be understood, tightening of the nuts 60 and/or 60a urges the fittings 10 and 10a towards each other. This, in turn, forces the opposing ends of the pipes 12, 12a against the resilient sealing member 56 thereby resulting in a fluid and pressure tight seal there-between. As indicated above, in a preferred embodiment, each of the flanges 54 and 54a comprises a radially extending flange. In this way, such flange could be provided with a number of holes to receive the connecting rods 58 thereby facilitating installation. Although nuts 60 and 60a are shown to be provided on opposing ends of the rods 58, it will be understood that one of such ends can be replaced with a bolt head that bears against flange 54 or 54a. Similarly, one of the nuts may be avoided by permanently fixing (by means of welding at the like) one end of the connecting rod 58 to the respective flange. In either case, it will be understood that tightening of the remaining nuts will provide the required force to bring the fittings together. In addition, although the tightening of the nuts 60 and 60a may exert a force upon the outer ring 16 to further extend over the inner ring 14, it will be appreciated that such force would be not be enough to unseat the upper ring 16.

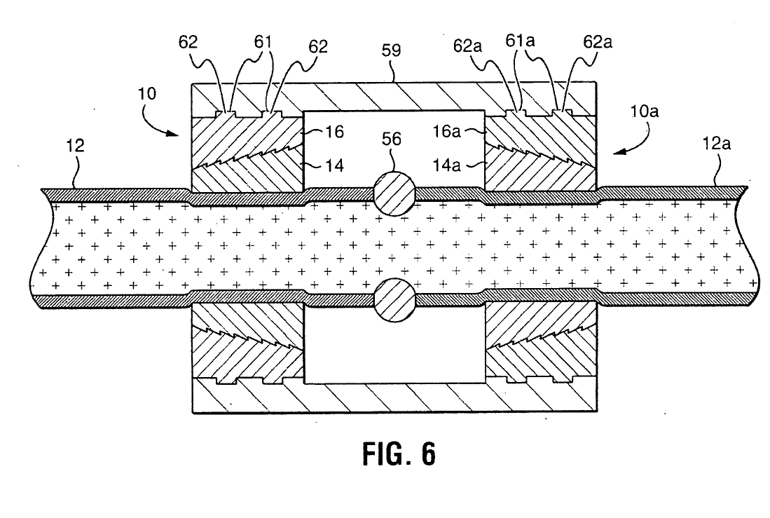

A further embodiment of the invention is illustrated in FIG. 6, wherein elements common to those discussed above are identified with the same reference numerals. In this case, the fittings 10 and 10a, as discussed with respect to FIG. 5, are secured or installed on the pipes 12 and 12a to be joined. The pipes 12 and 12a are placed in abutting alignment with a resilient seal 56 there-between. In the embodiment of FIG. 6, it is assumed that the fittings, and, in the result, the butt ends of the pipes, have been urged together so as to form a pressure tight seal there-between. After this, a clamp 59 is provided to maintain the required stress against the sealing member 56. In the embodiment shown in FIG. 6, the outer surfaces of the outer rings 16, 16a of the fittings 10 and 10a, respectively, are provided with one or more ribs 62 and 62a, respectively. The clamp 59, in turn, is provided with cooperating grooves 61 and 61a, adapted to receive ribs 62 and 62a. As will be understood, the grooves and ribs, 61, 61a, 62, 62a, engage each other and prevent axial separation of the fittings 10 and 10a. It will be understood that in another embodiment, the outer ring 16 may be provided with grooves adapted to receive cooperating ribs on the clamp 59.

The clamp 59 may comprise a ring that is sized to circumferentially overlap the fittings 10 and 10a. In such case, the clamp 59 would preferably be provided in two sections that can be clamped together or may include an axially extending hinge to facilitate installation of the clamp. Also, a ring shaped clamp may have a solid, cylindrical shape or may comprise a pair of opposed rings with a plurality of arms extending there-between. Various other arrangements of the clamp 59, for drawing the fittings 10 and 10a together, would be apparent to persons skilled in the art.

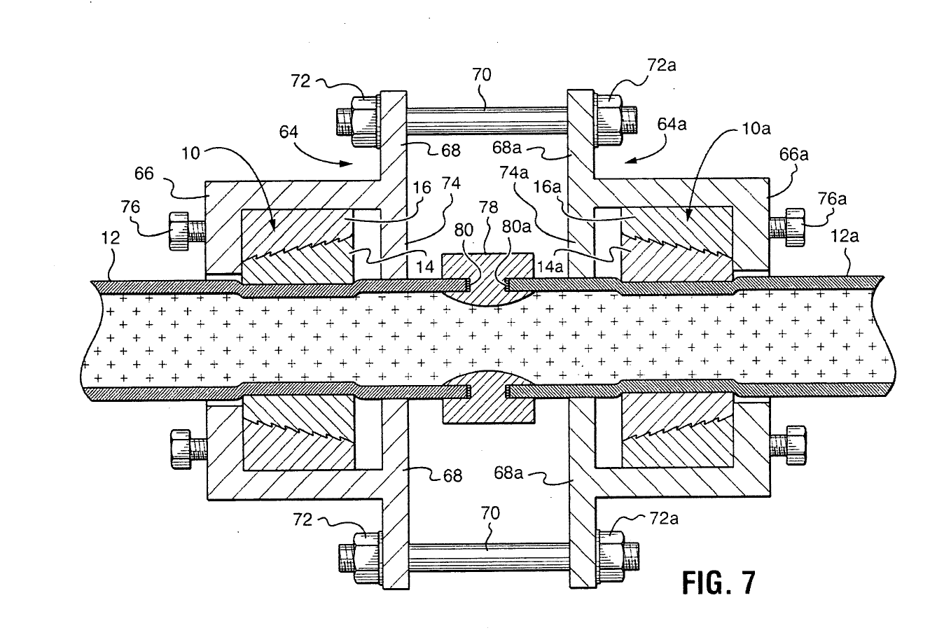

FIG. 7 illustrates a variation of the assembly shown in FIG. 5, wherein like elements are identified with the same reference numerals. FIG. 7 illustrates another embodiment for urging the fittings 10 and 10a together. In this case, the fittings do not include any flanges such as those shown in FIG. 5. The urging force is applied to the fittings 10, 10a by a plurality of connection brackets 64 and 64a. Connection brackets 64, 64a include posterior (that is, in a direction away from the butt joint between the pipes 12 and 12a), radially inwardly extending first arms 66, 66a, respectively, that bear against the first (or posterior) ends of the fittings 10, 10a. The brackets 64, 64a also include anterior (that is, in a direction towards the butt joint), radially outward extending second arms 68 and 68a, respectively. The second arms 68, 68a are provided with holes through which extend connection rods 70. Nuts 72 and 72a are provided on the posterior sides of the second arm's 68, 68a to secure the connection rods 70 to the brackets 64, and 64a. As will be understood, tightening of the nuts 72, 72a urges the brackets 64, 64a towards each other. In turn, the first arms 66 and 66a then impinge upon the fittings 10 and 10a thereby forcing the fittings axially towards each other. Since the fittings are secured to the pipes 12, 12a, the abutting ends are therefore axially forced against each other. The provision of a seal at such butt joint serves to ensure a pressure tight sealing arrangement. In one embodiment, the seal may simply comprise a gasket or O-ring or a seal such as depicted as element 56 in FIG. 6. A further variation of the seal is shown in FIG. 7 and comprises the use of a sealing ring 78, which is discussed further below.

The second arms 68 and 68a may optionally be provided with radially inwardly extending extensions 74, 74a, respectively, which serve to stabilize the second arms 68 and 68a when such arms are under tension (i.e. when the nuts 72, 72a are tightened).

As with the discussion of the assembly of FIG. 5, one set of the nuts 72 and 72a may be omitted by having one of the ends of the connecting rod 70 provided with a bolt head or by having such end permanently affixed to the second arm 68. Various other alternatives may be used for this purpose.

The brackets 64 and 64a may be individually provided at generally equidistant spacing about the circumference of the pipes 12, 12a. Alternatively, the brackets may be joined together as a generally cylindrical structure when installed. In such case, the structure will be provided in at least two parts which may be hinged to facilitate installation.

In order to enhance the seal between the butt joint of the pipes 12, 12a, the first arms 66 and 66a may be provided with threaded holes through which extend bolts 76 and 76a. Tightening of the bolts 76, 76a will result in a further tensioning force applied to the ends of the pipes 12, 12a, thereby applying a further sealing force.

FIG. 7 also illustrates a variation of a seal between the butt ends of the pipes 12, 12a. As shown, instead of a resilient sealing member being provided at the joint, a generally annular shaped sealing ring 78 is provided. The sealing ring 78 includes oppositely directed circular grooves 80, 80a that are adapted to receive, respectively, the ends of the pipes 12 and 12a. A resilient sealing member such as an O-ring, gasket etc. is provided within each groove 80, 80a to ensure a pressure tight seal is formed at the joint between the pipes 12, 12a.

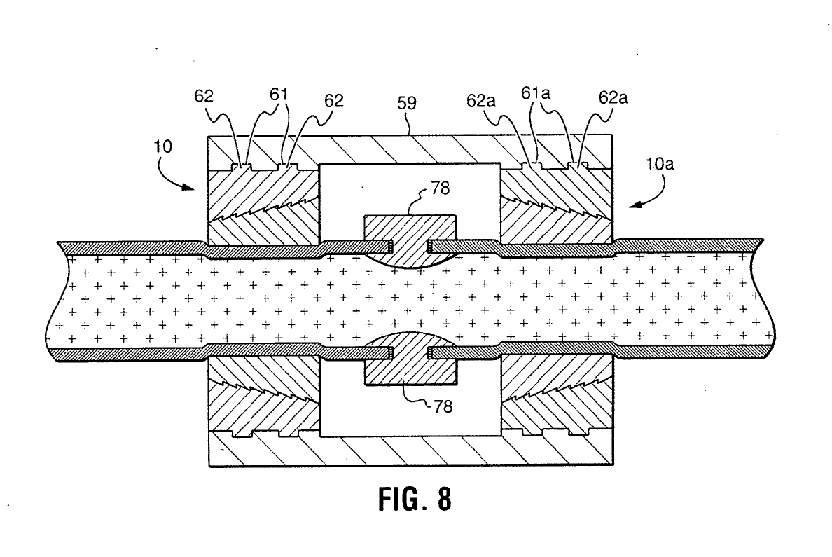

FIG. 8 illustrates the use of the clamp apparatus 59 shown in FIG. 6 with the sealing apparatus of FIG. 7. As described above, the clamp apparatus 59 serves to maintain the fittings 10 and 10a at the desired relative positions, thereby maintaining the seal between the pipes 12 and 12a.

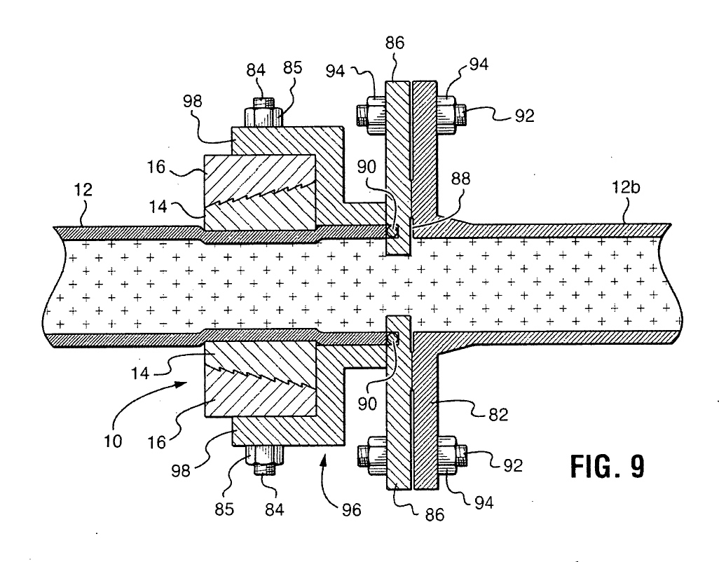

FIG. 9 illustrates another embodiment of the invention wherein elements similar to those discussed above are referred to with similar reference numerals. In some cases, the letter “b” is used to identify any elements that are different. FIG. 9 illustrates an embodiment wherein a flange is provided on a pipe without the need for welding etc. The embodiment shown in FIG. 9 is particularly suited for joining a plain end pipe 12 to another pipe 12b having a flange 82. As shown, a fitting 10 is installed on the pipe, proximal to one end thereof. The manner of installing the fitting 10, which includes an inner ring 14 and an outer ring 16, on the pipe 12 is the same as described above. In the embodiment shown, the outer surface of the outer ring 16 of the fitting is provided with a number of threaded boltholes (not shown), extending radially inward. The boltholes are adapted to receive bolts 84, which are described further below. At least two boltholes are generally provided; however, the number of holes will be apparent to persons skilled in the art and will depend upon a number of variables, one of which being the diameter of the pipe 12.

FIG. 9 also illustrates a flange assembly comprising a flange plate 86 adapted to cooperate with the end of the pipe 12. In one aspect, the flange plate 86 may include a circular groove 88 adapted to receive the end of the pipe 12. The groove 88 would preferably also include a resilient sealing member 90 in order to establish a fluid tight seal between wall of the pipe and the flange plate 86. The flange plate 86 would normally include a central opening generally corresponding to the lumen of the pipe 12. The flange plate 86 is adapted to connect to the flange 82 provided on the second pipe 12b. As is commonly known, such connection is typically achieved with a plurality of bolts 92 and nuts 94 that tightly seal the flange plate 86 to the flange 82. As is also commonly known, a gasket or other such sealing material (not shown) would preferably be provided at the interface between the flange plate 86 and flange 82 to ensure a fluid tight seal there-between.

A bracket assembly 96 connects the flange plate 86 to the fitting 10. The bracket includes a number of arms 98, one end of which are attached, preferably permanently, to the flange plate 86. The arms 98 extend in the same direction and are adapted to extend over the outer surface of the pipe 12. As shown, the arms 98 are preferably provided generally equidistantly over the circumference of the pipe 12. However, various other arrangements are possible within the scope of the invention. For example, the arms 98 may be replaced with a single annular body. However, it will be understood that the use of the arms 98 serves to reduce the weight of the bracket assembly. The ends of the arms 98 opposite the flange plate 86 are provided with boltholes to receive the bolts 84. Bolt heads 85 provided on the bolts 84 allow the bolts to be screwed to the outer ring 16 of the fitting 10, thereby connecting bracket assembly 96 to the fitting 10.

In setting up the apparatus of FIG. 9, the fitting 10 is first installed on the pipe 12. The flange plate 86 and bracket assembly 96 are then mounted against the end of the pipe 12 with the end of the pipe forming a seal with a portion of the flange plate 86. As explained above, one means of achieving such seal involves providing a groove in the flange plate, the groove including a resilient seal and being adapted to receive the end of the pipe 12. The flange plate and bracket assembly is advanced onto the pipe 12 until the boltholes provided on the arms and the outer ring 16 are aligned. Bolts 84 are then inserted through both boltholes and tightened to secure the bracket assembly 96 to the fitting 10. It will be understood that the connection of the bracket assembly 96 to the fitting 10 will force the end of the pipe 12 into the groove 88 provided on the flange plate 86, thereby forming a seal there-between. The force required to establish such seal can be achieved in various ways. For example, a clamp device (not shown) may be used to urge the flange plate and bracket assembly against the pipe 12. It will also be understood that the arms 98 of the bracket assembly 96 may include a series of boltholes to accommodate different or varying spacing of the fitting 10 and the end of the pipe 12.

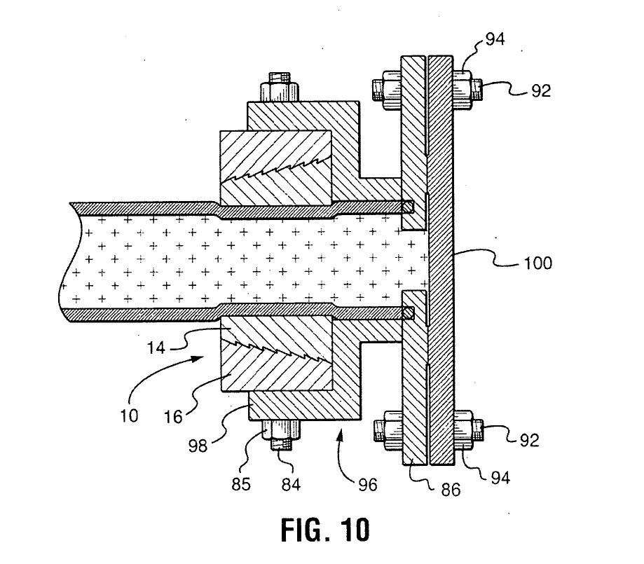

A further embodiment of the apparatus of FIG. 9 is shown in FIG. 10. In this case, the pipe 12, the fitting 10, the bracket assembly 96 and the flange plate 86 are essentially the same as described above. However, in this case, the second pipe (12b in FIG. 9) is not present and, instead, a blind flange 100 is secured to the outside surface of the flange plate 86. As known to persons skilled in the art, a blind flange serves to seal the interior of a pipe. As described above, any known sealing member may be provided at the interface of the flange plate 86 and the blind flange 100.

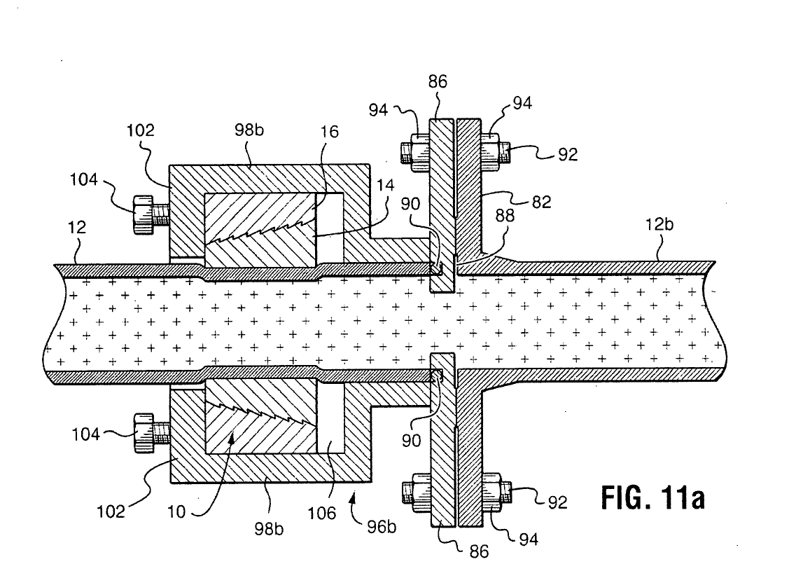

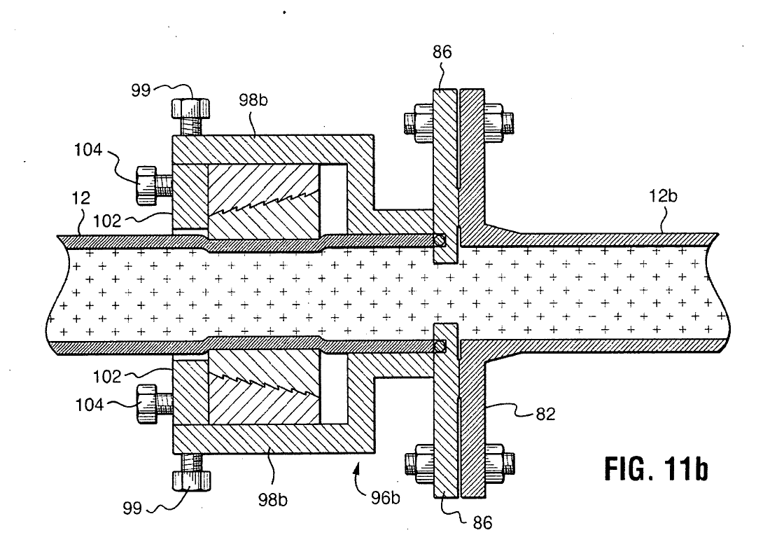

FIGS. 11a and 11b provide examples of an apparatus of FIG. 9 wherein a sealing force can be applied between the flange plate and the end of the pipe. Thus, FIGS. 11a and 11b illustrate variations of the embodiment shown in FIG. 9, wherein like elements are referred to with like reference numerals. Elements that are similar but are modified are identified with the same reference numeral but with the letter “b” added for clarity. In the embodiment shown in FIG. 11a, the arms 98a of the bracket assembly 96b are provided with extension arms 102 that engage the posterior end (that is the end opposite the flange plate 86) of the fitting 10. Provided on extension arms are threaded boltholes into which are provided bolts 104. The bolts 104 are designed so as to protrude through the extension arms 102 and to impinge upon the posterior end of the fitting 10. As will be understood as the bolts 104 are tightened, or advanced against the fitting 10, the bracket assembly 96a and the flange plate 86 are urged in the posterior direction thereby creating a sealing force between the end of the pipe 12 and the flange plate 86. As shown in FIG. 11a, a certain degree of clearance 106 is provided in the arms 98b to allow the bracket assembly 96b to move posteriorly over the fitting 10.

The extension arms 102 of the bracket assembly 96b may be integral with the arms 98b or may be fixedly joined thereto. Alternatively, as shown in FIG. 11b, the extension arms 102 may be connected to the arms 98b as separate pieces. Such connection may be achieved with bolts 99 that extend through holes in the arms 98b (not shown) and into threaded openings in the extension arms 102 (also not shown). The configuration of FIG. 11b may be preferred in order to have the bracket assembly accommodate various sizes of pipes 12, sizes and positions of fittings 10 and also to facilitate installation over the fittings. In one embodiment, the extension arms 102 shown in FIG. 11b may be replaced by an annular disc that is coaxial with the pipe 12. Alternatively, such disc may be provided in one or more sections and secured to the arms 98b.

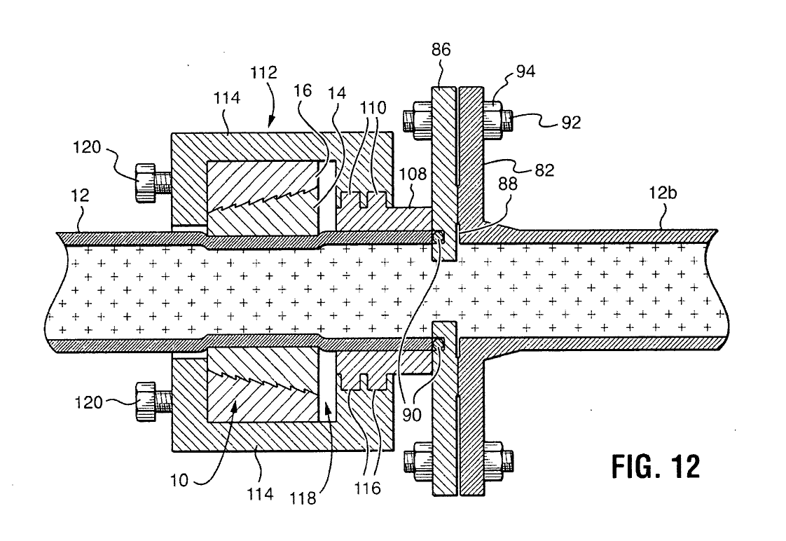

FIG. 12 illustrates another variation in the embodiment shown in FIGS. 9 to 11. Elements shown in FIG. 12 that are common to previous figures are referred to with similar reference numerals. FIG. 12 illustrates a flange connection between a first pipe 12 and a second pipe 12b. The second pipe 12b includes a flange 82 as commonly known in the art. The first pipe 12 is provided with a flange plate 86 as described above. Namely, the flange plate 86 preferably includes a groove 88, containing a resilient sealing member, into which is received an end of the first pipe 12. The first pipe 12 is also provided with a fitting 10 as described above. The flange plate 86 of FIG. 12 includes a cylindrical extension 108 extending generally coaxially over the pipe 12. In one embodiment, the extension 108 includes one or more ribs 110 on its outer surface.

A bracket assembly 112 is also provided for connecting the flange plate 86 to the fitting 10 via the extension 108. The bracket assembly comprises, in one embodiment, a number of arms 114 having anterior ends (that is proximal to the flange plate 86) and oppositely directed distal ends. The anterior ends of the arms 114 include grooves 116 adapted to receive the ribs 110 of the extension 108. The arms 114 have a generally “C” shaped cross section wherein a pocket 118 for receiving a portion of the fitting as the arms 114 extend axially there-over. The posterior ends of the arms 114 are provided with threaded boltholes (not shown) through which extend bolts 120. Tightening of the bolts 120 causes them to bear against the posterior ends of the fitting 10. Once the anterior ends of the arms are connected to the extension 108 by mating the grooves 116 and the ribs 110, it will be understood that tightening of the bolts 120 causes the bracket assembly 112 and the flange plate 86 to be advanced posteriorly, thereby forming a sealing force between the pipe 12 and the flange plate 86.

Although the extension 108 has been described above as having a generally cylindrical shape, it will be understood that such extension may also be provided by means of radiating arms. Similarly, although the bracket assembly 112 has been described as comprising a number of arms 114, it may also comprise a split cylinder (i.e. a “clamshell” design) that can be assembled on the pipe 12. Similarly, various other structural variations would be apparent to persons skilled in the art without departing from the scope of the present invention.

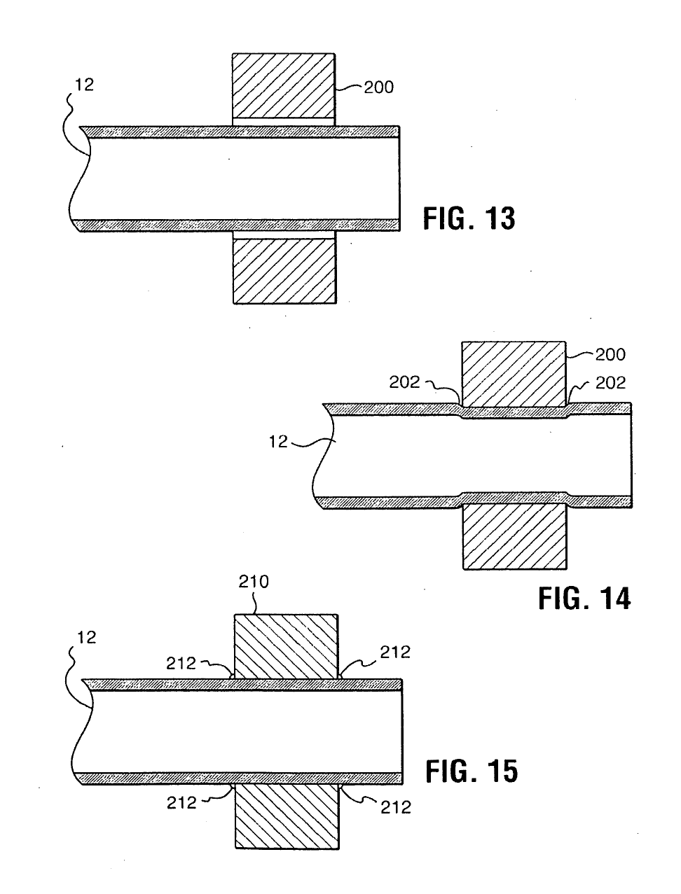

FIGS. 13 and 14 illustrate another embodiment of the invention wherein a fitting 200 is provided on a pipe 12. The fitting 200 of this embodiment comprises a single, annular shaped ring having an inner diameter smaller than the outer diameter of the pipe 12. FIG. 12 shows the fitting 200 in its installation state wherein such fitting is heated to expand its inner diameter to a size that is larger than the outer diameter of the pipe 12. In this heated, expanded state, the fitting 200 is slipped over the outer surface of the pipe 12. FIG. 14 illustrates the fitting 200 after it is cooled. In the cooling process, the size of the fitting becomes reduced thereby returning the inner diameter of the fitting to its normal value, which is less than the pipe's outer diameter. In the result, as shown in FIG. 14, the fitting 200 is squeezed over the pipe thereby leading to a localised swaging of the pipe. This results in ledges 202 being formed in the pipe outer wall, on each end of the fitting. These ledges 202 serve to prevent axial movement of the fitting 200 over the pipe 12.

In another embodiment, as shown in FIG. 15, a fitting of the invention may simply comprise a ring 210 having an inner diameter that is slightly greater than the outer diameter of the pipe 12. This enables the ring 210 to be slipped over the pipe and positioned at a desired axial location. At this point, the ring 210 is welded 212 to the pipe to prevent relative axial movement there-between.

It will be understood by persons skilled in the art that the fittings shown in FIGS. 13 to 15 may be used in any of the apparatus and assemblies shown in FIGS. 5 to 12 in place of the ratchet type fittings shown therein.

Although various embodiments of the invention are shown in the accompanying Figures, the invention will be understood as not being limited by any dimensions or relational sizes depicted.

Although the invention has been described with reference to certain specific embodiments, various modifications thereof will be apparent to those skilled in the art without departing from the purpose and scope of the invention as outlined in the claims appended hereto. The disclosures of all prior art recited herein are incorporated herein by reference in their entirety.

We claim:

1. A pipe fitting for circumferential attachment to a pipe by swaging comprising:
an inner ring adapted to be provided over the pipe; and,
an outer ring adapted to be provided over the inner ring;
said inner ring having an outer surface including a first set of teeth;
said outer ring having an inner surface including a second set of teeth;
wherein said first and second sets of teeth are adapted to engage each other as said outer ring is urged over the inner ring.

2. The pipe fitting of claim 1 wherein said inner and outer rings include opposing ramped surfaces, each of said surfaces being sloped in opposite directions and wherein said first and second sets of teeth are provided on said respective ramped surfaces.

3. The pipe fitting of claim 2 wherein said first and second sets of teeth are provided over substantially the entirety of the ramped surfaces.

4. The pipe fitting of claim 3 wherein said first and second set of teeth are oppositely directed with respect to each other thereby forming a ratcheting engagement between the inner and outer rings.

5. The pipe fitting of claim 4 wherein the tensile strength of the outer ring is greater than the tensile strength of the inner ring whereby urging of the outer ring over the inner ring is sufficient to cause radial compression of the inner ring over the pipe.

6. The pipe fitting of claim 5 further comprising a means for urging the outer ring over the inner ring.

7. The pipe fitting of claim 6 wherein said means for urging comprises at least one bracket;
said bracket being adapted to extend over the fitting and having a first end and a second end;
the bracket first end having a bearing surface to engage the inner ring;
the bracket second end having an actuator for urging the outer ring over the inner ring.

8. The pipe fitting of claim 7 wherein said actuator is chosen from the group consisting of: hydraulic cylinders, jack bolts, nuts and bolts, and combinations thereof.

9. The pipe fitting of claim 8 wherein said means for urging is removable.

10. A method of providing a fitting over a pipe comprising:
providing an inner ring over the pipe,
providing an outer ring adapted to fit over the inner ring;
urging the outer ring over the inner ring to cause radial compression of the inner ring over the pipe and thereby swaging of the pipe;
locking the respective axial positions of the inner and outer rings to prevent separation thereof.

11. The method of claim 10 wherein a ratchet system is used for locking the relative positions of the inner and outer rings.

12. A coupling assembly for joining the ends of first and second pipes comprising:
a first fitting adapted to be secured to the first pipe;
a second fitting adapted to be secured to the second pipe;
each of the first and second fittings comprising:
an inner ring adapted to be provided over the pipe; and,
an outer ring adapted to be provided over the inner ring;
said inner ring having an outer surface including a first set of teeth;
said outer ring having an inner surface including a second set of teeth;
wherein said first and second sets of teeth are adapted to engage each other as said outer ring is urged over the inner ring;
a connector joining the first and second fittings to prevent axial separation there-between.

13. The coupling assembly of claim 12 further including a seal provided between the pipe ends.

14. The coupling assembly of claim 13 wherein said connector also includes a means for urging the first and second fittings together thereby reinforcing the seal between the first and second pipes.

15. A method of joining the ends of pipes comprising:
providing a first fitting on a first pipe and a second fitting on a second pipe, each of said fittings comprising an inner and outer ring and each of said steps comprising:
a) providing an inner ring over the pipe;
b) providing an outer ring adapted to fit over the inner ring;
c) urging the outer ring over the inner ring to cause radial compression of the inner ring over the pipe and thereby swaging of the pipe;
d) locking the respective axial positions of the inner and outer rings to prevent separation thereof;
axially aligning said first and second pipes and providing a seal there-between;
urging said pipes together; and,
connecting the first and second fittings to prevent relative movement there-between.

16. A coupling assembly for joining the ends of first and second pipes wherein said second pipe is provided with a flange, the assembly comprising:
a fitting adapted to be secured to the first pipe, said fitting comprising:
an inner ring adapted to be provided over the pipe; and,
an outer ring adapted to be provided over the inner ring;
said inner ring having an outer surface including a first set of teeth;
said outer ring having an inner surface including a second set of teeth;
wherein said first and second sets of teeth are adapted to engage each other as said outer ring is urged over the inner ring; and,
a flange plate connected to said fitting, said flange plate comprising:
a generally annular disc having a central aperture corresponding to the lumen of the first pipe and a seal for sealingly engaging the end of the first pipe; and,
including bolt holes corresponding to bolt holes on said flange of the second pipe.

17. A method of coupling a first pipe to a second pipe having a flange comprising:
providing a fitting on the first pipe comprising the steps of:
a) providing an inner ring over the first pipe;
b) providing an outer ring adapted to fit over the inner ring;
c) urging the outer ring over the inner ring to cause radial compression of the inner ring over the first pipe and thereby swaging of the first pipe;
d) locking the respective axial positions of the inner and outer rings to prevent separation thereof;
providing a flange plate over an end of the first pipe, the flange plate covering the opening of the first pipe;
connecting the flange plate to the fitting;
axially aligning an end of said first pipe with the flange end of the second pipe and urging said pipes together; and,
securing the flange plate of the first pipe to the flange of the second pipe.

18. A coupling assembly for sealing the end of a pipe comprising:
a fitting adapted to be secured to the pipe, said fitting comprising:
an inner ring adapted to be provided over the pipe; and,
an outer ring adapted to be provided over the inner ring;
said inner ring having an outer surface including a first set of teeth;
said outer ring having an inner surface including a second set of teeth;
wherein said first and second sets of teeth are adapted to engage each other as said outer ring is urged over the inner ring; and,
a flange plate connected to said fitting, said flange plate comprising:
a generally annular disc having a central aperture corresponding to the lumen of the first pipe and a seal for sealingly engaging the end of the first pipe; and,
a plurality of circumferentially spaced bolt holes; and,
a blind flange for securing to the flange plate.

19. A method of providing a fitting over a pipe comprising:
providing a metal collar formed of a thermally expandable material, said collar having an inner diameter that is smaller than the external diameter of the pipe;
heating the collar to expand the inner diameter;
inserting the pipe through the collar inner diameter;
cooling the collar to return the collar inner diameter to the non-expanded size;
whereby said collar swages the pipe.
